(19) United States
(12) Patent Application Publication
(10) Pub. No.: US 2019/0130276 A1
(43) Pub. Date: May 2, 2019

(54) TENSOR MANIPULATION WITHIN A NEURAL NETWORK

(71) Applicant: Wave Computing, Inc., Campbell, CA (US)

(72) Inventors: Kenneth Shiring, San Jose, CA (US); Stephen Curtis Johnson, Morgan Hill, CA (US)

(21) Appl. No.: 16/170,268

(22) Filed: Oct. 25, 2018

Related U.S. Application Data
(60) Provisional application No. 62/577,902, filed on Oct. 27, 2017.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.

(51) Int. Cl. G06N 3/08; G06N 3/04

(52) U.S. Cl. CPC G06N 3/084; G06N 3/04

(57) ABSTRACT

Techniques are disclosed for tensor manipulation within a neural network and include training the neural network. An input tensor is obtained for manipulation within a deep neural network. The input tensor includes fixed-point numerical representations and tensor metadata and is applied to a layer within the deep neural network. The input tensor has variable radix points associated with the fixed-point values of the input tensor. A weighting tensor including metadata is determined for the input tensor applied to the layer. An output tensor is calculated from the layer within the deep neural network based on the input tensor and the weighting tensor. The output tensor has fixed-point values with a second set of variable radix points associated with the fixed-point values of the output tensor. The output tensor includes tensor metadata. The output tensor is propagated within the deep neural network.

### RELATED APPLICATIONS

This application claims the benefit of U.S. provisional patent applications “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to computational manipulation and more particularly to tensor manipulation within a neural network.

### BACKGROUND

The trend of business, researchers, and governments to collect data has resulted in vast and ever-expanding datasets. The datasets are commonly referred to as “big data”. These collectors and other entities are interested in being able to process these vast datasets and to perform a wide range of tasks using the data. The tasks can include learning, marketing, and predicting, among many others. Conventional architectures, processors, and techniques cannot process and analyze the “big data” datasets for the simple reason that the analysis overwhelms the computational capabilities of the conventional systems and approaches. In addition to data access, the analysis, capture, maintenance, storage, transmission, visualization, and so on, can quickly overwhelm the capabilities of the traditional systems. With no ability to process the data, there would be little or no value to the data. Instead, new processing algorithms, heuristics, techniques, and so on are required. Those who possess the datasets or have access to the datasets, are eager to perform a variety of analysis tasks on the data contained in the datasets. Common analysis purposes include: business analysis; complex science and engineering simulations; crime detection and prevention; disease detection, tracking, and control; and meteorology; to name only a few. Advanced data analysis techniques such as predictive analytics are interesting because they can be used for extracting value from the datasets for business and other purposes. Other uses for the datasets include machine learning and deep learning.

Neural networks, commonly called artificial neural networks (ANN) mimic biological neural networks. These computational systems “learn” based on developing improved system performance while executing a given task. The task can include image recognition, speech recognition, and other computationally intensive applications. This “learning”, called machine learning, is based on the premise that computers can be trained to perform a task without being specifically programmed to do so. The training builds algorithms to learn using a known dataset (supervised learning). The algorithms can then be used to make predictions about the current and future datasets. The advantage of machine learning is that the algorithms are based on models. The algorithms can adapt and improve over time based on past experience with data such as prediction success rates and error rates. A model is constructed from a set of sample data with known characteristics. The model is trained using the known data to make desired predictions and decisions. Once the model has been trained, the model is applied to other datasets. The model can be updated over time based on the success rate of the model to make correct predictions using the data. Applications of such machine learned models include: network and system intrusion detection; optical character recognition (OCR); email filtering for spam detection, computer vision (CV); and so on. The success of the model is limited by the quality of the training data. Analysis of the training data often requires human intervention, so such analysis is both expensive and at risk of human error.

Deep neural networks (DNN) are a form of artificial neural networks (ANN). Like artificial neural networks, the deep neural networks are based on layers. For the deep neural networks, there can be multiple hidden layers between the input layer and the output layer. DNNs are well suited to modeling complex, non-linear relationships. A DNN can be used to generate a compositional model. A compositional model can support automatic formulation of models using explicit representation for modeling assumptions. The compositional model can be expressed as a layered composition of primitive data types. The additional layers of the DNN can support formulation of features from lower layers of the composition. The result can be modeling the complexities of data using fewer computational resources.

### SUMMARY

Neural networks can be used to process vast quantities of unstructured data. The neural networks can manipulate tensors, where the tensors can represent the data including the unstructured data. Neural networks are finding many data processing applications in diverse fields such as machine learning, including deep learning, artificial intelligence, business and research applications such as trend analysis, and so on. Von Neumann and other traditional control flow computational architectures are not well suited to highly data-intensive processing requirements. Although designers and architects continue to construct faster processors, improved custom integrated circuits or chips, more capable application specific integrated circuits (ASIC), and so on, the new designs and architectures still fail to meet the data processing demands because these architectures are not designed specifically for processing vast amounts of data. An alternative architecture to the control flow architectures is based on data flow. In a data flow architecture, the execution of instructions, functions, subroutines, etc., is based on the presence or absence of data. This latter approach, that of a data flow architecture, is better suited to handling the large amounts of unstructured data that are processed as part of the machine learning and deep learning applications.

Neural networks can be implemented using a reconfigurable fabric comprised of processing elements, switching elements, and/or memory elements. In order to train the nodes (neurons) of a neural network to “think,” training data can be applied to the neural network. The results from each layer of nodes based on the training data can then be propagated forward to achieve an end result. Error data can then be generated by comparing the neural network result of processing the training data to a desired result included with the training data. The error data can then be backward propagated into the network to fine tune the weightings of each layer. The training process can be iterated until desired results are achieved.

Tensor manipulation within a neural network is realized using a reconfigurable fabric. The reconfigurable fabric includes processing elements, switching elements, memory elements, communications capabilities, and so on. Embodiments include a computer-implemented method for computational manipulation comprising: obtaining a first input tensor for manipulation within a deep neural network, wherein the first input tensor includes fixed-point numerical representations, and wherein the first input tensor includes tensor metadata; applying the first input tensor to a first layer within the deep neural network, wherein the first input tensor with fixed-point values has a first set of variable radix points, wherein the first set of variable radix points is associated with the fixed-point values of the first input tensor; determining a first weighting tensor for the first input tensor applied to the first layer, wherein the first weighting tensor includes tensor metadata; calculating a first output tensor from the first layer within the deep neural network based on the first input tensor and the first weighting tensor, wherein the first output tensor has fixed-point values with a second set of variable radix points, wherein the second set of variable radix points is associated with the fixed-point values of the first output tensor, and wherein the first output tensor includes tensor metadata; and propagating the first output tensor within the deep neural network. In embodiments, the tensor metadata is determined for each tensor. In embodiments, the tensor metadata for each tensor includes tensor dimension, tensor element count, tensor radix points, tensor element precision, tensor element range, or tensor element classification. In embodiments, each set of radix points is determined per tensor.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for tensor manipulation within a neural network.

FIG. 2 is a flow diagram for tensor metadata inclusion.

FIG. 3 shows an example layer.

FIG. 4 illustrates example layers with forward propagation and backward propagation.

FIG. 5A shows example fixed radix point representations.

FIG. 5B shows example variable radix point representations.

FIG. 6 illustrates an example first layer and an example second layer.

FIG. 7 shows a deep learning block diagram.

FIG. 8 illustrates a cluster for coarse-grained reconfigurable processing.

FIG. 9 shows a block diagram of a circular buffer.

FIG. 10 illustrates a circular buffer and processing elements.

FIG. 11 is a system diagram for computational manipulation for tensor manipulation within a neural network.

### DETAILED DESCRIPTION

Techniques are disclosed for tensor manipulation within a neural network. A tensor is a convenient mathematical structure for use in many neural network applications. However, data can be stored using many different schemas, and the disclosed techniques are applicable to other data structures besides tensors, such as list structures and tree structures. Neural networks, such as deep neural networks, convolutional neural networks, and so on, are being developed to handle highly complex data processing requirements such as those presented by “big data”. The immense datasets associated with big data can overwhelm conventional, control-based computer hardware techniques including those based on Von Neumann techniques. In addition to the challenges of handling and storing the sheer volumes of data, the data itself can have large dynamic ranges. That is, the data can include very small values and very large values. Choosing a number representation scheme is critical to handling the large dynamic ranges, accuracy requirements, saturation hazards, and so on. Number representation schemes can include fixed-point representations and floating-point representations. The former is computationally simple and can handle accuracy requirements until the fixed-point values saturate or overflow. Saturation can occur when a number or a result of an operation cannot be represented by the number of digits available to the fixed-point number representation scheme. Floating-point techniques can handle large dynamic ranges of numbers, but suffer from roundoff error and an inability to handle small numbers and large number concurrently in various operations. For example, adding a small number to a large number can leave the large number unchanged. In addition, manipulation of floating-point representations is more computationally intensive.

To address architectural and data handling issues, a deep neural network can be realized using a reconfigurable fabric. The reconfigurable fabric includes communications capabilities and elements that can be configured to perform various operations. The reconfigurable fabric can include elements that can be configured as processing elements, switching elements, or memory elements. Configuration and control of the elements can be controlled by rotating circular buffers. By loading instructions into a given circular buffer, the instructions can configure the element associated with the circular buffer and can enable the element to operate on data, which can include s very large quantities of data. The rotating circular buffers can be statically scheduled, so that processing time is saved by avoiding the reloading of instructions into the circular buffers. In addition to the use of the reconfigurable fabric for the processing of large datasets, a number representation scheme based on variable radix points and fixed-point representations can be used. The variable radix points can be used to handle a wide, dynamic range of data values, and the variable radix point fixed-point number representation scheme can be used to both simplify computations and reduce data storage requirements.

Tensor manipulation is performed within a neural network. A first input tensor is obtained for manipulation within a deep neural network, where the first input tensor includes fixed-point numerical representations, and where the first input tensor includes tensor metadata. The tensor metadata for each tensor can include tensor dimension, tensor element count, tensor radix points, tensor element precision, tensor element range, or tensor element classification. The first input tensor is applied to a first layer within the deep neural network, where the first input tensor with fixed-point values has a first set of variable radix points, and where the first set of variable radix points is associated with the fixed-point values of the first input tensor. A first weighting tensor is determined for the first input tensor applied to the first layer, where the first weighting tensor includes tensor metadata. A first output tensor is calculated from the first layer within the deep neural network based on the first input tensor and the first weighting tensor, where the first output tensor has fixed-point values with a second set of variable radix points, where the second set of variable radix points is associated with the fixed-point values of the first output tensor, and where the first output tensor includes tensor metadata. The variable radix points associated with input tensors can be determined by heuristic and computational techniques. Computational techniques can be very costly calculations in terms of processing multidimensional tensors through a large, deep, complex neural network. Heuristic techniques can be far less costly from a computational standpoint, but must be developed to provide a high quality variable radix point set for the input tensors, weighting tensors, and output tensors of a deep neural network.

Tensor metadata can be integral to performing variable radix point calculations within a neural network implemented on a reconfigurable fabric. Tensor metadata can include tensor dimension, tensor element count, tensor radix points, tensor element precision, tensor element range, or tensor element classification. The tensor dimension can include the order, degree, rank, etc., of one or more arrays that can be used to represent the tensor. The tensor metadata can be used along with the tensor as it is applied to a layer within a neural network. The tensor metadata can be included to determine radix points for both the tensor being applied to a neural network layer and a resulting output tensor. The output tensor can be used as an input tensor for a next layer of the neural network.

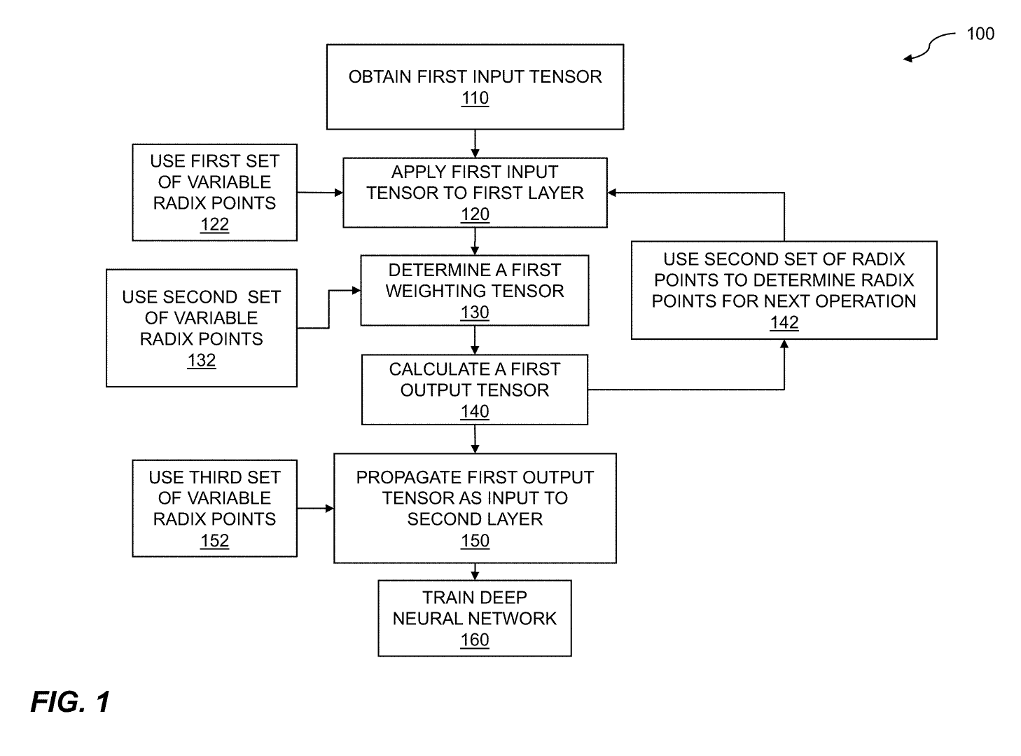

FIG. 1 is a flow diagram for tensor manipulation within a neural network. The flow 100 includes obtaining a first input tensor 110 for manipulation within a deep neural network, wherein the first input tensor includes fixed-point numerical representations, and wherein the first input tensor includes tensor metadata. The tensor can include a plurality of arrays. In embodiments, a tensor is a multidimensional matrix. The number of dimensions in the multidimensional matrix that can represent a tensor can vary based on the tensor. In embodiments, the tensor can be three-dimensional. In other embodiments, the tensor can be four-dimensional. The tensor can include a greater number of dimensions. The neural network can include the deep neural network (DNN), a convolutional neural network (CNN), and so on. The first input tensor can include a fixed-point numerical representation, where the fixed-point numerical representation can include a number of bits, digits, bytes, words, etc. The fixed-point numerical representation can include a fixed radix point, where the fixed radix point can include a decimal point, a binary point, an octal point, a hexadecimal point, and the like. The radix point can be placed such that there are zero or more digits to the left of the radix point, zero or more digits to the right of the radix point, and so on. The fixed-point numerical representation can include a set of variable radix points. In embodiments, each set of radix points can be determined per tensor. The tensor metadata can be determined for each tensor. In embodiments, the tensor metadata for each tensor can include tensor dimension, tensor element count, tensor radix points, tensor element precision, tensor element range, or tensor element classification. The tensor dimension can include the order, degree, rank, etc., of one or more arrays that can be used to represent the tensor.

The flow 100 includes applying the first input tensor to a first layer 120 within the deep neural network, wherein the first input tensor with fixed-point values has a first set of variable radix points, wherein the first set of variable radix points is associated with the fixed-point values of the first input tensor. The first layer can be an input layer, an output layer, a hidden layer, and so on, in the deep neural network or other neural network. The first set of variable radix points 122 associated with the first input tensor can be used for the applying. The first set of variable radix points associated with the first input tensor with fixed-point values can be used to increase precision, to normalize, to reduce saturation, to reduce roundoff errors, and the like. The set of variable radix points can be associated with an input tensor, shared by two or more tensors, and so on. In embodiments, the first set of variable radix points can have different radix points for different blocks within the first input tensor. The flow 100 includes determining a first weighting tensor 130 for the first input tensor applied to the first layer, wherein the first weighting tensor includes tensor metadata. The weighting tensor can be obtained, loaded from a library, downloaded from the Internet and so on. A second set of variable radix points 132 can be used for the determining. The second set of variable radix points can be associated with a weighting tensor, a scaling tensor, a normalizing tensor, and so on.

In embodiments, the deep neural network is implemented using a reconfigurable fabric. Reconfigurable fabrics can include arrays or clusters of elements. The reconfigurable fabric can be implemented as a custom integrated circuit or chip, a system on a chip (SoC), and so on. Reconfigurable fabrics can be applied to many applications where high-speed transferring and processing of data is performed. In embodiments, the reconfigurable fabric comprises processing elements, switching elements, or memory elements. The reconfigurable fabric can also include communications and interconnection capabilities. In embodiments, the elements can be controlled by rotating circular buffers. The rotating circular buffer can be loaded with instructions that can be used to control the processing elements. In embodiments, the rotating circular buffers can be statically scheduled. The static scheduling can include loading instructions into the circular buffers and controlling the circulation of the circular buffers. The circulation of the circular buffers allows execution of the instructions stored in the circular buffers.

The flow 100 includes calculating a first output tensor 140 from the first layer within the deep neural network based on the first input tensor and the first weighting tensor, wherein the first output tensor has fixed-point values with a second set of variable radix points, wherein the second set of variable radix points is associated with the fixed-point values of the first output tensor, and wherein the first output tensor includes tensor metadata. The calculating can be based on Boolean operations, convolution, rectification, such as a rectified linear unit (ReLU), pooling, max pooling, addition, multiplication, and so on. The flow 100 further includes using the second set of variable radix points to determine variable radix points for a next operation 142 by the first layer. The using of the second set of variable radix points can include scaling, normalization, saturation, reduction, and so on.

The flow 100 includes propagating the first output tensor as an input to a second layer 150 within the deep neural network, with a set of radix points for the input to the second layer. When two or more layers are included in the deep neural network, the first layer can be an input layer, a hidden layer, and so on. The second layer can be a hidden layer, an output layer, etc. The propagating, or using, of the first output tensor as an input to the second layer can include using a third set of variable radix points 152. The third set of variable radix points can be associated with an input vector, a weighting vector, and the like. The flow 100 includes training the deep neural network 160, based on the obtaining, the applying, the determining, and the calculating. The training can include supervised training, unsupervised training, partially supervised training, and so on. The training can include training layers of the deep neural network by changing values of one or more weighting tensors. In embodiments, the training can include forward propagation of activations. An activation can define an output based on one or more inputs. The activation can be propagated to modify a task or operation performed by one or more nodes in a layer. In embodiments, the training can include backward propagation of error. The backward propagation of error can be used to update activations, to update weights, and so on, or to improve convergence, to reduce error, etc. In embodiments, the propagating, or using, of the first output tensor is in the backward direction for training. In embodiments, the first input tensor comprises deep neural network user training data. Various steps in the flow 100 may be changed in order, repeated, omitted, or the like without departing from the disclosed concepts. Various embodiments of the flow 100 may be included in a computer program product embodied in a non-transitory computer readable medium that includes code executable by one or more processors.

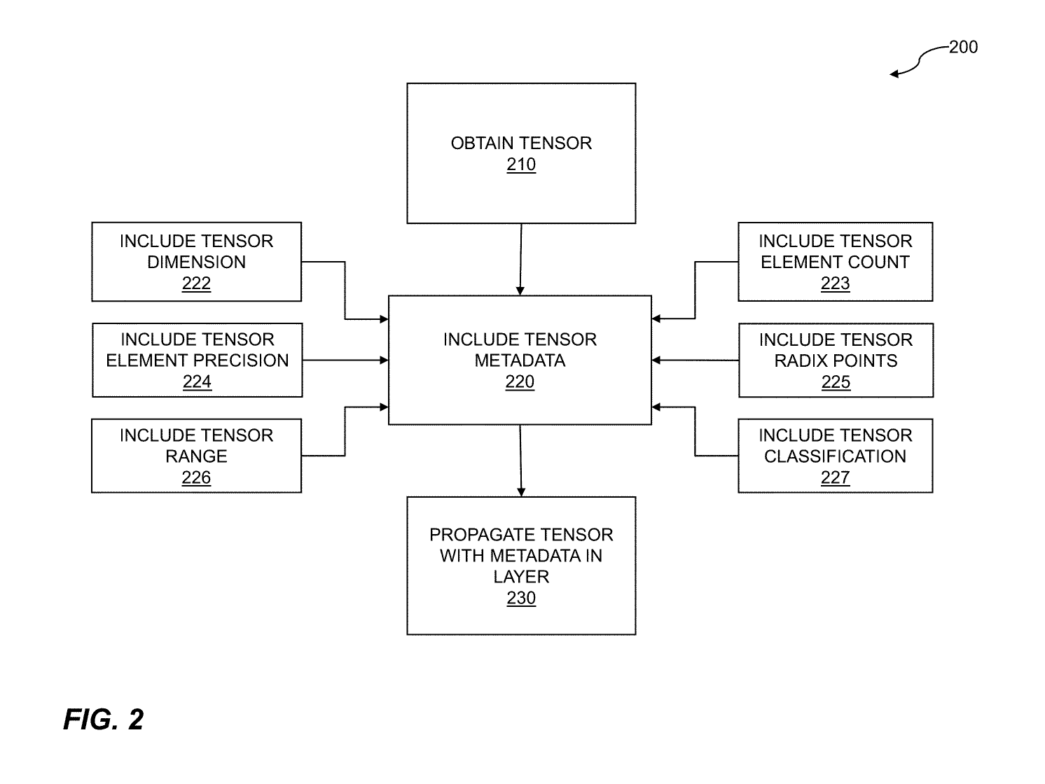

FIG. 2 is a flow diagram for tensor metadata inclusion. Tensors are manipulated within neural networks such as deep neural networks, convolutional neural networks, and so on. The tensors can include metadata. A first input tensor is obtained for manipulation within a deep neural network, where the first input tensor includes fixed-point numerical representations, and where the first input tensor also includes tensor metadata. The tensor metadata for each tensor can include tensor dimension, tensor element count, tensor radix points, tensor element precision, tensor element range, or tensor element classification. The first input tensor is applied to a first layer within the deep neural network, where the first input tensor with fixed-point values has a first set of variable radix points, and where the first set of variable radix points is associated with the fixed-point values of the first input tensor. A first weighting tensor is determined for the first input tensor applied to the first layer, where the first weighting tensor includes tensor metadata. A first output tensor is calculated from the first layer within the deep neural network based on the first input tensor and the first weighting tensor, where the first output tensor has fixed-point values with a second set of variable radix points, where the second set of variable radix points is associated with the fixed-point values of the first output tensor, and where the first output tensor includes tensor metadata.

The flow 200 includes obtaining a tensor 210. A tensor can be a multidimensional array. The tensor can include a first tensor for manipulation within a deep neural network (DNN). The tensor can include input data, output data, weights, etc. The first tensor can include one or more fixed-point representations. The fixed-point representations can include fixed radix point representations, variable radix point representations, and so on. The flow 200 includes tensor metadata 220. The tensor metadata can be used to further describe the tensor, to aid computations based on the tensor, etc. The tensor metadata can include a tensor dimension 222. The tensor dimension can include the order, degree, rank, etc., of one or more arrays that can be used to represent the tensor. The tensor metadata can include tensor element precision 224. Tensors can be described in terms of elements, where the elements can be related to tensor products. The tensor element precision can include a number of bits, digits, bytes, words, and so on that can be used to describe the tensor. The tensor metadata can include tensor range 226. Tensor range can include values that can be assigned to the tensor such as [1, 2, 3, 4], [3, 6, 9, 12, 15], and so on.

The included tensor metadata 220 can include tensor element count 223. The tensor element count can include a count of the number of occurrences of a given element in the tensor. An element count for an element “1” in tensor [2, 1, 0, 1, 1, 2] is 3. The tensor metadata can include tensor radix points 225. The tensor radix points can include a set of radix points, where the set of radix points can include variable radix points. The tensor metadata can include tensor classification 227. Tensor classification can include vectorizing tensor data and applying regression techniques. The regression techniques can include classification techniques. The flow 200 includes propagating, or using, tensor metadata in a layer 230. The tensor metadata can be associated with an input tensor to a layer, a weighting tensor for a layer, an output tensor from a layer, etc. In embodiments, the weighting tensor can include tensor metadata. Various steps in the flow 200 may be changed in order, repeated, omitted, or the like without departing from the disclosed concepts. Various embodiments of the flow 200 may be included in a computer program product embodied in a non-transitory computer readable medium that includes code executable by one or more processors.

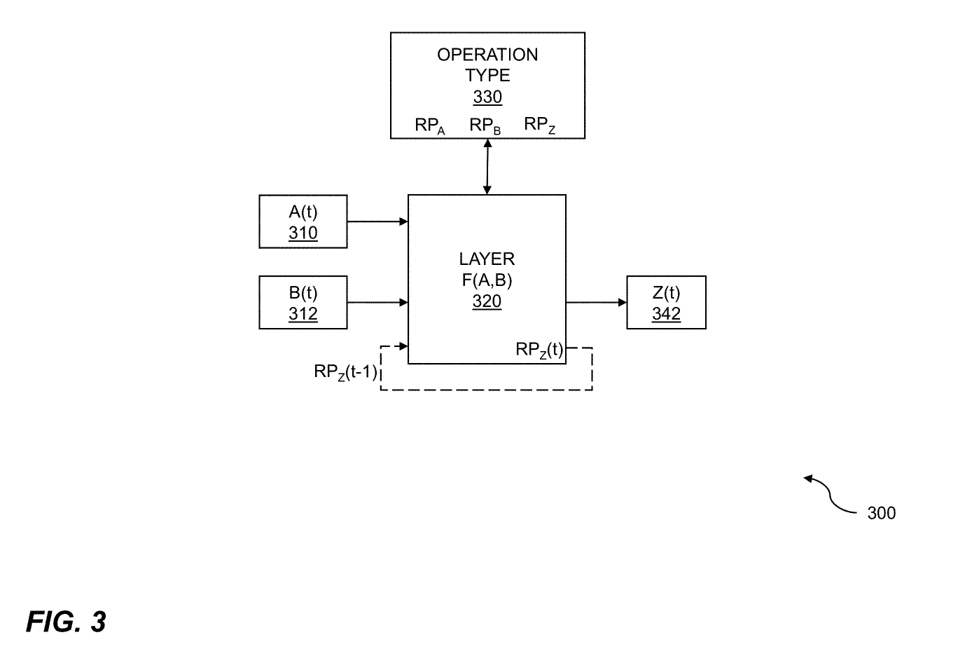

FIG. 3 shows an example layer. Layers such as input layers, output layers, hidden layers, and so on can be included in neural networks. Neural networks such as deep neural networks (DNN), convolutional neural networks (CNN), and so on, can be applied to deep learning and other techniques. The neural networks can manipulate data types including tensors. Layers support tensor manipulation within a neural network. An example 300 can include layer F(A, B) 320. The layer 320 can include an input A(t) 310 and an input B(t) 312. The layer 320 includes implementation of function F(A, B), where the function F is based on inputs A and B. The input A(t) 310 can include fixed-point values, variable radix point values, tensors, vectors, and so on. The input B(t) 312 can also include values such as weights. The inputs A and B are a function of time tin the sense that at a certain point in time, inputs A and B will have certain values. At a later point in time, for example, t+1, inputs A and B may have different values associated with a subsequent cycle. At an earlier point in time, for example, t−1, inputs A and B may have different values associated with a previous cycle. Similarly, other inputs and/or outputs to layer 320, such as a variable radix point, designated by RP_{Z}(t) can have a time dependency. The point in time and the later point in time can represent various data being processed by the layer in the neural network. In embodiments, a first weighting tensor can have fixed-point values with a third set of variable radix points, where the third set of radix points can be associated with the fixed-point values of the first weighting tensor. The layer 320 can receive a set of radix points. In embodiments, a second set of variable radix points can be a function of a preceding set of variable radix points associated with fixed-point values of a previous output tensor. The set of radix points can include radix points from a previous computation, such as radix points RP_{Z}(t−1). The layer 320 can include an operation type 330. The operation type 330 can include a convolution, a rectification such as a rectified linear unit (ReLU), pooling such as max pooling, Boolean operations, addition, multiplication, and so on. The operation type can operate on values such as tensors. The tensors can include a set of variable radix points. The operation type 330 can include a set of variable radix points for input A1, RP_{A}; a set of variable radix points for input B1, RP_{B}; a set of variable radix points from another operation RP_{Z}; and the like. In embodiments, the first set of variable radix points has different radix points for different blocks within the first input tensor. The layer 320 can produce an output Z(t) 342. The output Z can be a tensor with an associated set of variable radix points RP_{Z}(t). As discussed above, the associated set of variable radix points can be used by layer 320 or another layer for another operation.

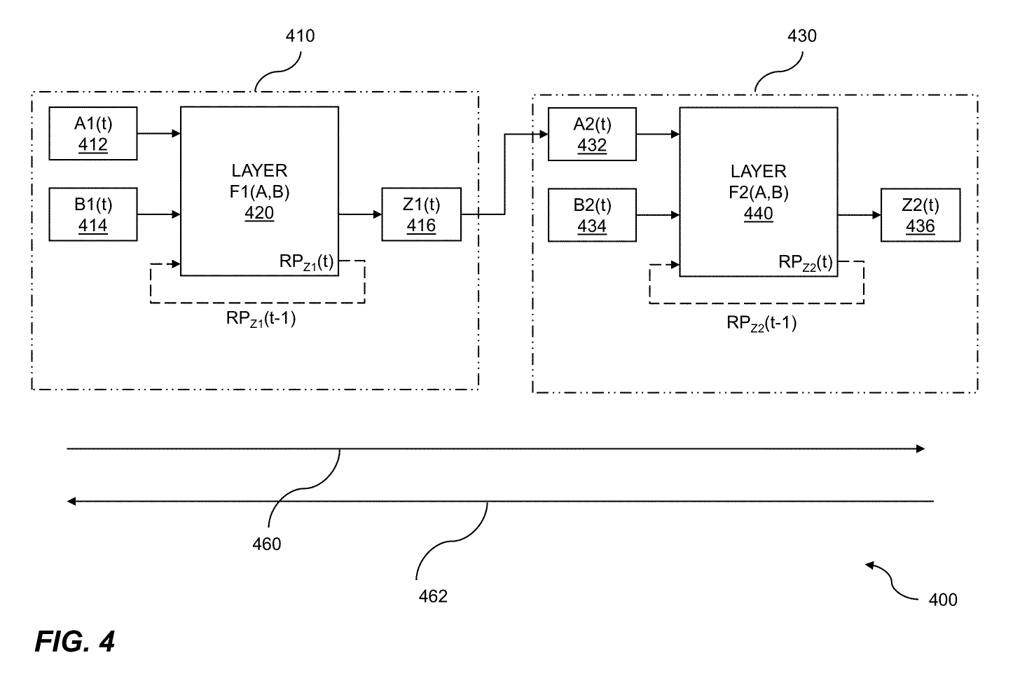

FIG. 4 illustrates example layers 400 with forward propagation and backward propagation. The example layers can represent layers in a deep neural network (DNN), a convolutional neural network (CNN), and so on. The forward propagation and the backward propagation can be used for tensor manipulation within a neural network. Example layers 400 are shown. The layers can include an input layer, an output layer, a fully connected layer, hidden layers, and so on. Two layers are shown, layer 410 and layer 430. A layer 410 includes an input A1(t) 412 and an input B1(t) 414. Input A1(t) can be a tensor, a vector, a fixed-point number, and so on. Input B1(t) can include weights, data, etc. The layer 410 includes a layer operation F1(A, B) 420. The layer operation 420 can include a Boolean operation, a convolution, a rectified linear unit (ReLU), a pooling operation such as a max pooling operation, addition, multiplication, and so on. The layer operation 420 can determine an output Z1(t) 416. The layer operation 420 can determine a set of radix points such as RP_{Z1}(t). The set of radix points can be fed back, becoming a set of radix points RP_{Z1}(t−1) for the next layer operation 420. A layer 430 includes an input A2(t) 432, and an input B2(t) 434. In embodiments, the first output tensor can be propagated, or used, as an input to a second layer within the deep neural network with a set of radix points for the input to the second layer. The input A2(t) 432 can include an output from another layer, such as Z1(t) 416 from layer 410. The input B2(t) can include weights, etc. The layer 430 includes a layer operation F2(A, B) 440. As for layer operation 420, layer operation 440 can include a Boolean operation, a convolution, a ReLU, a pooling operation, an addition, a multiplication, etc. The layer operation 440 can produce an output Z2(t) 436, a set of radix points RP_{Z2}(t), etc. The set of radix points can be fed back as RP_{Z2}(t−1) to the next operation of layer operation 440.

The layer 410 and the layer 430 can be layers in a deep neural network, a convolutional neural network, and so on. When the layers are included in a neural network for learning such as deep learning, weights used by a given layer can be updated as part of a learning technique. The learning technique can include training the neural network. The weights can include input B1(t) 414, input B2(t) 434, etc. The updating of the weights can be based on forward propagation 460, on backward propagation 462, on forward propagation and backward propagation, and so on. For forward propagation 460, the updating of weights such as weights B2(t) 434 can be based on an output from a stage, such as Z1(t) 416. In embodiments, the training includes forward propagation of activations. For backward propagation 462, the updating of weights such as weights B1(t) 414 can be based on an output from a stage, such as Z2(t) 436. In embodiments, the training includes backward propagation of error. The forward propagation 460 and the backward propagation 462 can be used to adjust tensors such as weighting tensors. In embodiments, the adjusting further includes adjusting the first weighting tensor based on the forward propagation and the backward propagation.

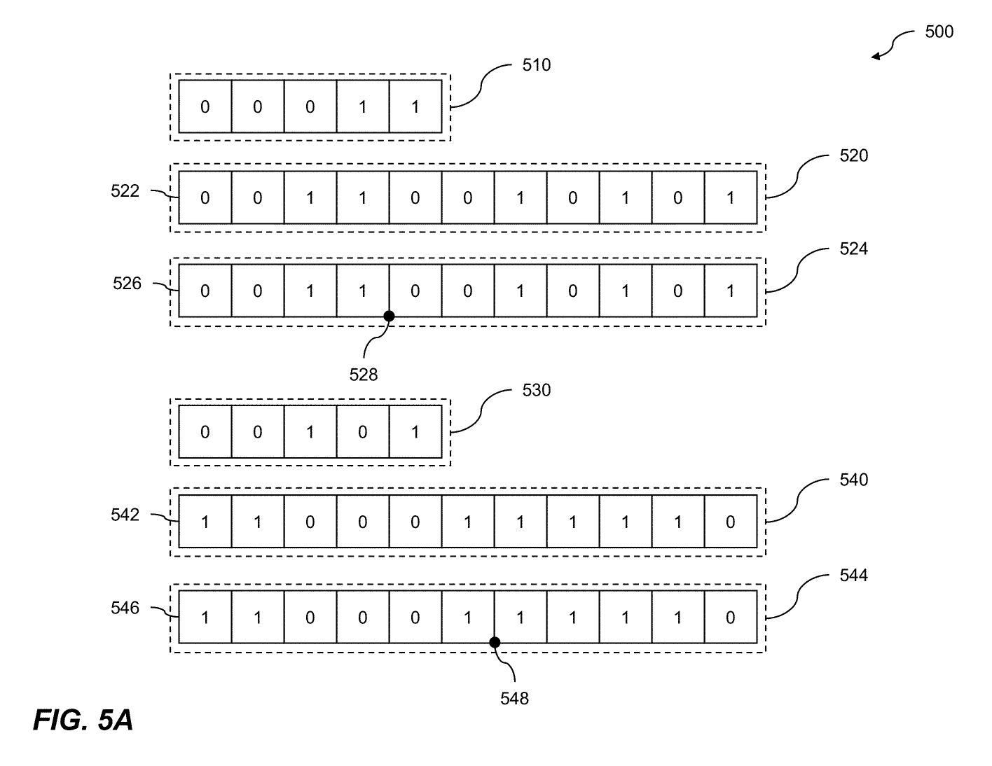

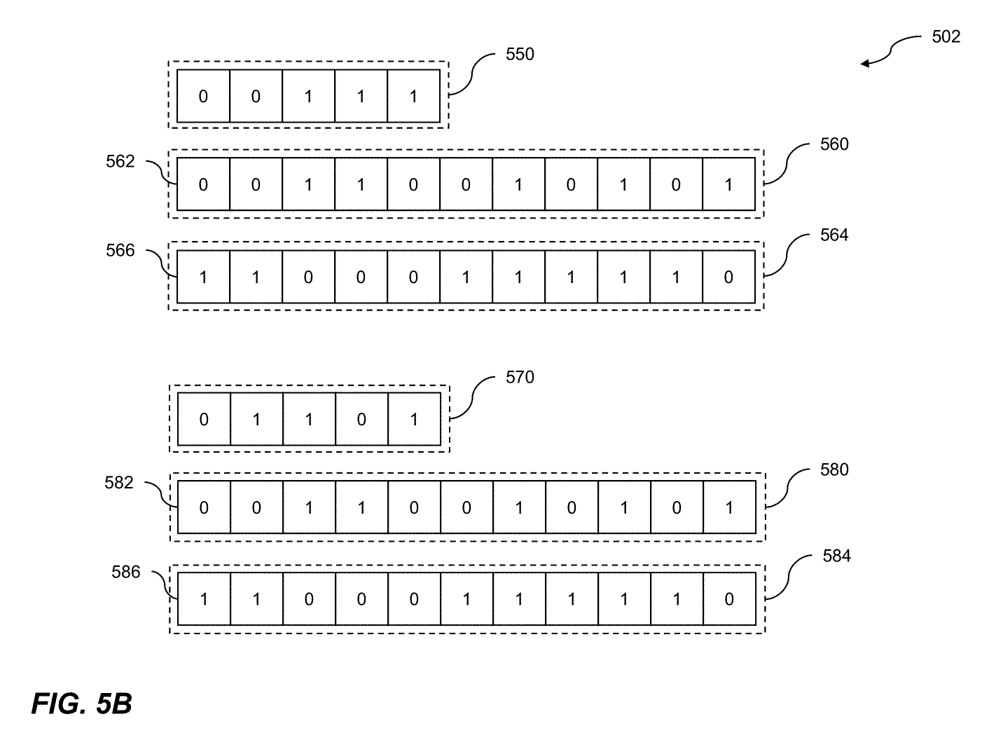

FIG. 5A shows example fixed radix point representations. Fixed radix point representations of numbers can represent tensors. The tensors can be manipulated within a neural network. The neural network, such as a deep neural network (DNN), a convolutional neural network (CNN), and so on, can be used for deep learning and other techniques. Real data types can be represented by fixed-point representations, where the fixed-point representation can include a fixed or implied radix point, shown in example 500. For the fixed-point representation, there can be a specific number of digits to the left of the radix point, and a specific number of digits to the right of the radix point. The number of digits to the right or to the left of the radix point can be zero digits. The number of digits to the left of the radix point can be the integer portion of a number, and the number of digits to the right of the radix point can be the fractional portion of a number. The radix point can be a binary point, a decimal point, an octal point, a binary-coded decimal point, a hexadecimal point, and so on, depending on the numbering scheme chosen for a given task. A scaling factor, such as scaling factor 510 and scaling factor 530 can imply the location of the radix point. The implied scaling factor 510 implies that the radix point can be positioned with three integer digits to the left of the radix point. In addition, a sign bit can be the leftmost digit, as shown by digits 522, 526, 542, and 546. Similarly, the implied scaling factor 530 can imply that the radix point can be positioned with five digits to the left of the radix point. Other scaling factors can be used including zero digits to the left of the radix point, all digits to the left of the radix point, digits to the right of the radix point, and so on.

A group of bits 520 is shown with an implied radix point and a sign bit digit 522. The implied radix point can be determined by a scaling factor 510. The sign bit digit 522 can be a zero to indicate that the number represented by the group of bits 520 is a positive number. An analogous group of bits 524 is shown with the implied radix point indicated by a large dot 528. A sign bit digit 526 is again shown. The group of bits 524 can be equivalent to the group of bits 520, with the addition of the implied radix point explicitly shown by large dot 528. Again, the sign bit digit 526 can be a zero to indicate that the number represented by the group of bits 524 is a positive number. Positive numbers and negative numbers can be represented using techniques such as signed magnitude, ones' complement, twos' complement, and so on. In addition to leftmost digit sign bit digit 526, the group of bits 524 can have three integer digits to the left of the implied radix point, indicated by large dot 528 and implied by the scaling factor 510.

A group of bits 540 is shown with an implied radix point and a sign bit digit 542. The sign bit digit 542 can be a one to indicate that the number represented by group of bits 540 is negative. A previously stated, the radix point can be implied by scaling factor 530. Scaling factor 530 is the binary representation of a five, which implies there can be five integer digits to the left of the implied radix point. A group of bits 544, analogous to the group of bits 540, is shown with the implied radix point indicated by large dot 548. The implied radix point large dot 548 can be determined by the scaling factor 530. Thus, the group of bits 544 has a left most digit for sign bit digit 546 and then five integer digits to the left of the implied radix point large dot. In example 500, the sign bit digit 546 of the group of bits 544 can be a one, which can indicate that the number represented is a negative number.

FIG. 5B shows example variable radix point representations. The variable radix representations 502 can be used for real data types, integer data types, and so on. The values represented by the variable radix representations can be scaled for accuracy, normalization, and other operations. A number 560 can have a sign bit digit 562. A number 564 can have a sign bit digit 566. A sign bit digit with a value of zero can indicate a positive number. A sign bit digit with a value of one can indicate a negative number. The numbers 560 and 564 can include a radix point (not shown). The scaling factor 550 can be used to scale numbers such as numbers 560 and 564 based on powers of a radix. For example, if numbers represented by digits of numbers such as numbers 560 and 564 are radix two numbers, then the scaling factor will be by powers of two. The value represented by scaling factor 550 is 2²+2¹+2⁰=4+2+1=7. Seven is used as the exponent for the radix of the scaling factor. The numbers 560 and 564 are scaled by 2⁷, where the scaling technique can include shifting left seven positions. The scaling factors can include a sign bit. A positive sign bit can indicate scaling by shifting left, and a negative sign bit can indicate scaling by shifting right.

Two other numbers, number 580 and number 584, are shown with a scaling factor 570. The number 580 can have a sign bit 582, and the number 584 can have a sign bit 586. As discussed above, a sign bit with a value of zero can indicate that the number with which the sign bit is associated is a positive number, and a sign bit with a value of one can indicate that the number with which the sign bit is associated is a negative number. The scaling factor 570 can be calculated as 2³+2²+0+2⁰=8+4+0+1=13. Thirteen is used as the exponent for the radix of the scaling factor 570. The number 580 and the number 584 are scaled by 2¹³, where the scaling technique can include shifting left number 580 and number 584 by thirteen positions.

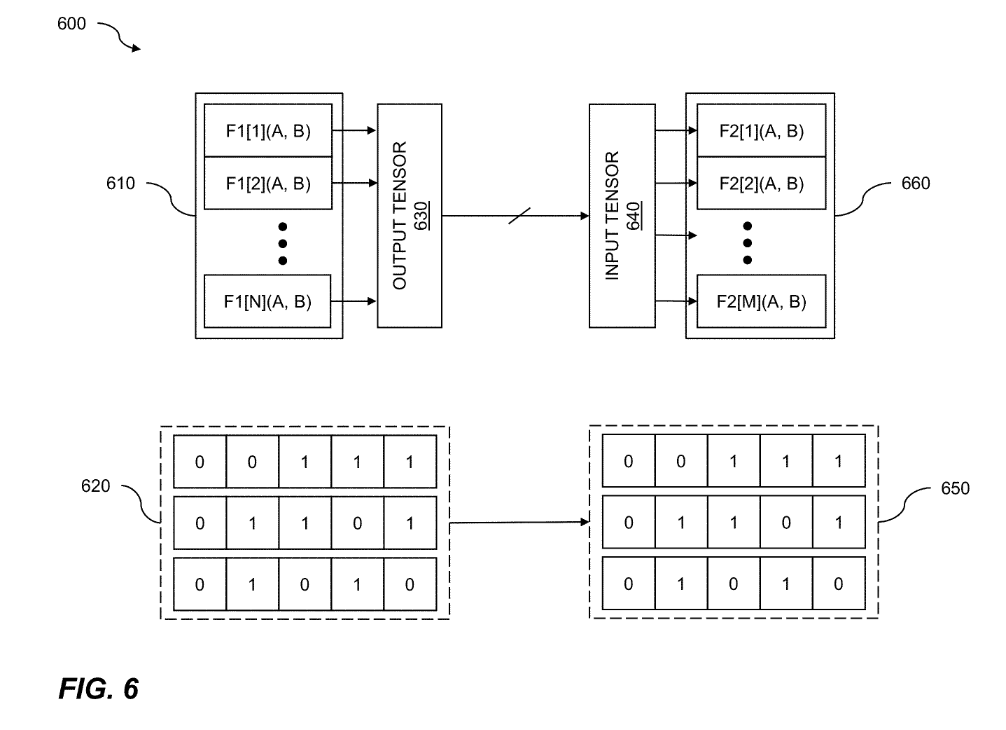

FIG. 6 illustrates an example first layer and an example second layer. The first layer and the second layer 600 can be layers of a neural network such as a deep neural network (DNN), a convolutional neural network (CNN), and so on. The first layer and the second layer can be layers within a neural network within which tensor manipulation can be performed. The layers of a deep neural network can include an input layer, an output layer, hidden layers, and so on. A first layer 610 can perform an operation. The operation, such as an operation F1(A,B), can include one or more nodes such as nodes F1[1](A,B), F1[2](A,B), . . . , up to F1[N](A,B). The operations can include Boolean operations, mathematical operations, neural network operations, etc. The operations can include convolution, rectification with a rectified linear unit (ReLU), pooling such as max pooling, addition, multiplication, and the like. The values of the results of the operations performed by the first layer 610 can include variable radix points 620. The quantity of variable radix points 620 can be based on the range of values operated upon by operation contained in first layer 610. In embodiments, each set of radix points can be determined per tensor. The set of radix points associated with a tensor can be included as input to a second layer or another layer. In embodiments, each set of variable radix points determined per tensor can also be determined per tensor dimension. The tensor dimension can include the order, degree, rank, etc., of one or more arrays that can be used to represent the tensor. The first layer can compute an output tensor 630. The output tensor can be stored with a register or using another storage technique. The output tensor 630 can be coupled to a register or other storage technique used for attaching an input tensor 640 to a second layer 660. The input tensor can include values that can include variable radix points 650. The quantification of variable radix points 650 can depend on the range of values to be operated upon by the operation of second layer 660. A second layer can perform an operation. The operation, such as an operation F2(A,B), can include one or more nodes such as nodes F2[1](A,B), F2[2](A,B), . . . , up to F2[M](A,B). As with the operation of the first layer, the operation of the second layer can include Boolean operations, mathematical operations, neural network operations, etc. The operations can include convolution, rectification with a rectified linear unit (ReLU), pooling such as max pooling, addition, multiplication, and so on. A deep neural network can include many such layers, and each layer can comprise many such nodes.

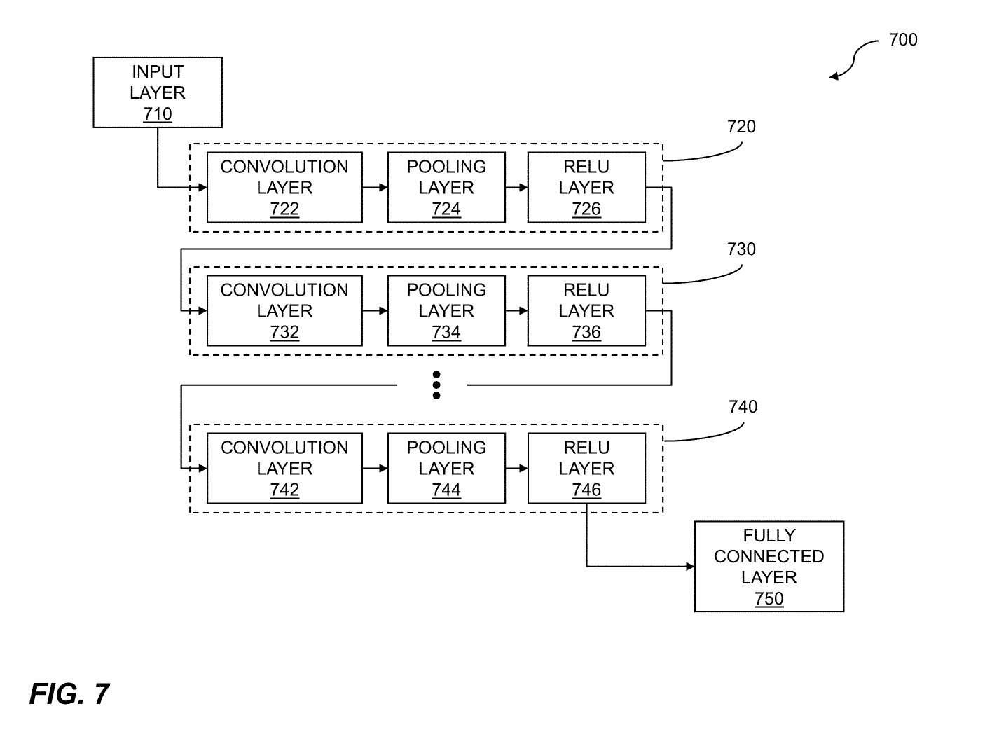

FIG. 7 shows a deep learning block diagram. Deep learning can be based on convolutional neural networks, where the convolutional neural networks can be organized in layers or other more general graph structures. The deep learning block diagram 700 can include a neural network such as a deep neural network (DNN). Tensor manipulation can be performed within a neural network. A deep learning block diagram 700 is shown. The block diagram can include various layers, where the layers can include an input layer, hidden layers, a fully connected layer, and so on. In some embodiments, the deep learning block diagram can include a classification layer. The input layer 710 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 700, which can represent a network such as a convolutional neural network, can contain a plurality of hidden layers. While three hidden layers, hidden layer 720, hidden layer 730, and hidden layer 740 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 720 can include convolution layer 722, pooling layer 724, and ReLU layer 726; layer 730 can include convolution layer 732, pooling layer 734, and ReLU layer 736; and layer 740 can include convolution layer 742, pooling layer 744, and ReLU layer 746. The convolution layers 722, 732, and 742 can perform convolution operations; the pooling layers 724, 734, and 744 can perform pooling operations, including max pooling, such as data down-sampling; and the ReLU layers 726, 736, and 746 can perform rectification operations. A convolutional layer can reduce the amount of data feeding into a fully connected layer. The block diagram 700 can include a fully connected layer 750. The fully connected layer can be connected to each data point from the one or more convolutional layers.

Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs organized in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus, the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit (SDK) can be in an agent library. The agent source code can be created using a variety of tools, where the tools can include MATMUL™, Batchnorm™, Relu™ and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

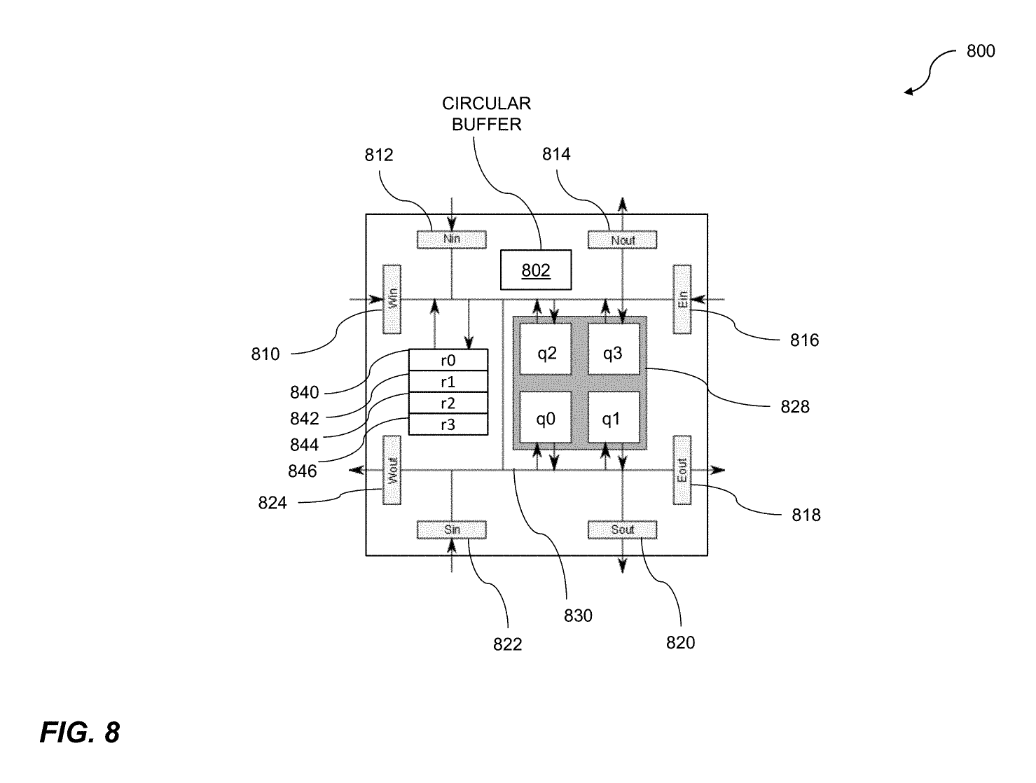

FIG. 8 illustrates a cluster for coarse-grained reconfigurable processing. The cluster 800 for coarse-grained reconfigurable processing can be used for tensor manipulation within a neural network. Data can be obtained from a first switching unit, where the first switching unit can be controlled by a first circular buffer. Data can be sent to a second switching element, where the second switching element can be controlled by a second circular buffer. The obtaining of data from the first switching element and the sending of data to the second switching element can include a direct memory access (DMA). The cluster 800 comprises a circular buffer 802. The circular buffer 802 can be referred to as a main circular buffer or a switch-instruction circular buffer. In some embodiments, the cluster 800 comprises additional circular buffers corresponding to processing elements within the cluster. The additional circular buffers can be referred to as processor instruction circular buffers. The example cluster 800 comprises a plurality of logical elements, configurable connections between the logical elements, and a circular buffer 802 controlling the configurable connections. The logical elements can further comprise one or more of switching elements, processing elements, or storage elements. The example cluster 800 also comprises four processing elements—q0, q1, q2, and q3. The four processing elements can collectively be referred to as a “quad,” and can be jointly indicated by a grey reference box 828. In embodiments, there is intercommunication among and between each of the four processing elements. In embodiments, the circular buffer 802 controls the passing of data to the quad of processing elements 828 through switching elements. In embodiments, the four processing elements 828 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 800 can further comprise storage elements coupled to the configurable connections. As shown, the cluster 800 comprises four storage elements—r0 840, r1 842, r2 844, and r3 846. The cluster 800 further comprises a north input (Nin) 812, a north output (Nout) 814, an east input (Ein) 816, an east output (Eout) 818, a south input (Sin) 822, a south output (Sout) 820, a west input (Win) 810, and a west output (Wout) 824. The circular buffer 802 can contain switch instructions that implement configurable connections. For example, an instruction effectively connects the west input 810 with both the north output 814 and the east output 818 and this routing is accomplished via bus 830. The cluster 800 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 802. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out through the output port. In other situations, the preprocessor can change one switching instruction to another switching instruction to avoid a conflict. For example, in some instances the preprocessor can change an instruction placing data on the west output 824 to an instruction placing data on the south output 820, such that the data can be output on both output ports within the same pipeline cycle. In a case where data needs to travel to a cluster that is both south and west of the cluster 800, it can be more efficient to send the data directly to the south output port rather than to store the data in a register first, and then send the data to the west output on a subsequent pipeline cycle.

An L2 switch interacts with the instruction set. A switch instruction typically has a source and a destination. Data is accepted from the source and sent to the destination. There are several sources [e.g. any of the quads within a cluster, any of the L2 directions (North, East, South, West), a switch register, or one of the quad RAMs (data RAM, IRAM, PE/Co Processor Register)]. As an example, to accept data from any L2 direction, a “valid” bit is used to inform the switch that the data flowing through the fabric is indeed valid. The switch will select the valid data from the set of specified inputs. For this to function properly, only one input can have valid data, and all other inputs must be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from a single input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing shared access to them by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

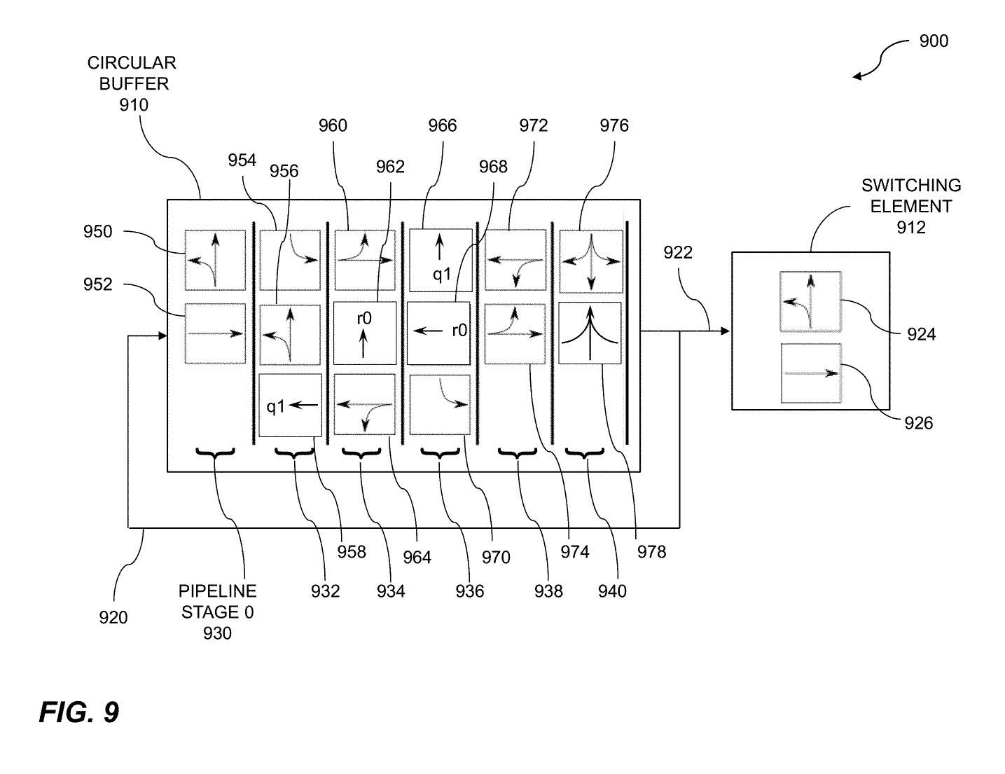

FIG. 9 shows a block diagram 900 of a circular buffer 910. The circular buffer 910 can include a switching element 912 corresponding to the circular buffer. The circular buffer and the corresponding switching element can be used in part for tensor manipulation within a neural network including a deep neural network (DNN). Data can be obtained from a first switching unit, where the first switching unit can be controlled by a first circular buffer. Data can be sent to a second switching element, where the second switching element can be controlled by a second circular buffer. Obtaining data from the first switching element and sending data to the second switching element can include a direct memory access (DMA). The block diagram 900 describes a processor-implemented method for data manipulation. The circular buffer 910 contains a plurality of pipeline stages. Each pipeline stage contains one or more instructions, up to a maximum instruction depth. In the embodiment shown in FIG. 9, the circular buffer 910 is a 6×3 circular buffer, meaning that it implements a six-stage pipeline with an instruction depth of up to three instructions per stage (column). Hence, the circular buffer 910 can include one, two, or three switch instruction entries per column. In some embodiments, the plurality of switch instructions per cycle can comprise two or three switch instructions per cycle. However, in certain embodiments, the circular buffer 910 supports only a single switch instruction in a given cycle. In the block diagram 900 shown, Pipeline Stage 0 930 has an instruction depth of two instructions, instructions 950 and 952. Though the remaining pipeline stages 1-5 are not textually labeled in the block diagram 900, the stages are indicated by callouts 932, 934, 936, 938, and 940. Pipeline Stage 1 932 has an instruction depth of three instructions, instructions 954, 956, and 958. Pipeline Stage 2 934 has an instruction depth of three instructions, instructions 960, 962, and 964. Pipeline Stage 3 936 also has an instruction depth of three instructions, instructions 966, 968, and 970. Pipeline Stage 4 938 has an instruction depth of two instructions, instructions 972 and 974. Pipeline Stage 5 940 has an instruction depth of two instructions, instructions 976 and 978. In embodiments, the circular buffer 910 includes 64 columns. During operation, the circular buffer 910 rotates through configuration instructions. The circular buffer 910 can dynamically change operation of the logical elements based on the rotation of the circular buffer. The circular buffer 910 can comprise a plurality of switch instructions per cycle for the configurable connections.

The instruction 952 is an example of a switch instruction. In embodiments, each cluster has four inputs and four outputs, each designated within the cluster's nomenclature as “north,” “east,” “south,” and “west” respectively. For example, the instruction 952 in the block diagram 900 is a west-to-east transfer instruction. The instruction 952 directs the cluster to take data on its west input and send out the data on its east output. In another example of data routing, the instruction 950 is a fan-out instruction. The instruction 950 instructs the cluster to take data from its south input and send out on the data through both its north output and its west output. The arrows within each instruction box indicate the source and destination of the data. The instruction 978 is an example of a fan-in instruction. The instruction 978 takes data from the west, south, and east inputs and sends out the data on the north output. Therefore, the configurable connections can be considered to be time-multiplexed.

In embodiments, the clusters implement multiple storage elements in the form of registers. In the block diagram 900 shown, the instruction 962 is a local storage instruction. The instruction 962 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining of data from a first switching element and the sending of the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. The arrival of valid data can prompt a cluster to be awoken during a DMA operation. The DMA instruction can be executed while the cluster remains asleep and awaits the arrival of valid data. Upon arrival of the valid data, the cluster is awoken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 958 is a processing instruction. The instruction 958 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the block diagram 900 shown, the circular buffer 910 rotates instructions in each pipeline stage into the switching element 912 via a forward data path 922, and also back to the Pipeline Stage 0 930 via a feedback data path 920. Instructions can include switching instructions, storage instructions, and processing instructions, among others. The feedback data path 920 can allow instructions within the switching element 912 to be transferred back to the circular buffer. Hence, the instructions 924 and 926 in the switching element 912 can also be transferred back to Pipeline Stage 0 as the instructions 950 and 952. In addition to the instructions depicted on FIG. 9, a no-op instruction can also be inserted into a pipeline stage. In embodiments, a no-op instruction causes execution to not be performed for a given cycle. In effect, the introduction of a no-op instruction can cause a column within the circular buffer 910 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 958, assuming that the processor q1 was previously in a sleep state. In embodiments, when the instruction 958 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 966. In the case of the instruction 966, data from the processor q1 is moved to the north output. In some embodiments, if Xs have been placed into the processor q1, such as during the instruction 958, then Xs would be retrieved from the processor q1 during the execution of the instruction 966 and would be applied to the north output of the instruction 966.

A collision occurs if multiple instructions route data to a particular port in a given pipeline stage. For example, if instructions 952 and 954 are in the same pipeline stage, they will both send data to the east output at the same time, thus causing a collision since neither instruction is part of a time-multiplexed fan-in instruction (such as the instruction 978). To avoid potential collisions, certain embodiments use preprocessing, such as by a compiler, to arrange the instructions in such a way that there are no collisions when the instructions are loaded into the circular buffer. Thus, the circular buffer 910 can be statically scheduled in order to prevent data collisions. In embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 962), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instructions can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through both the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0 which thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

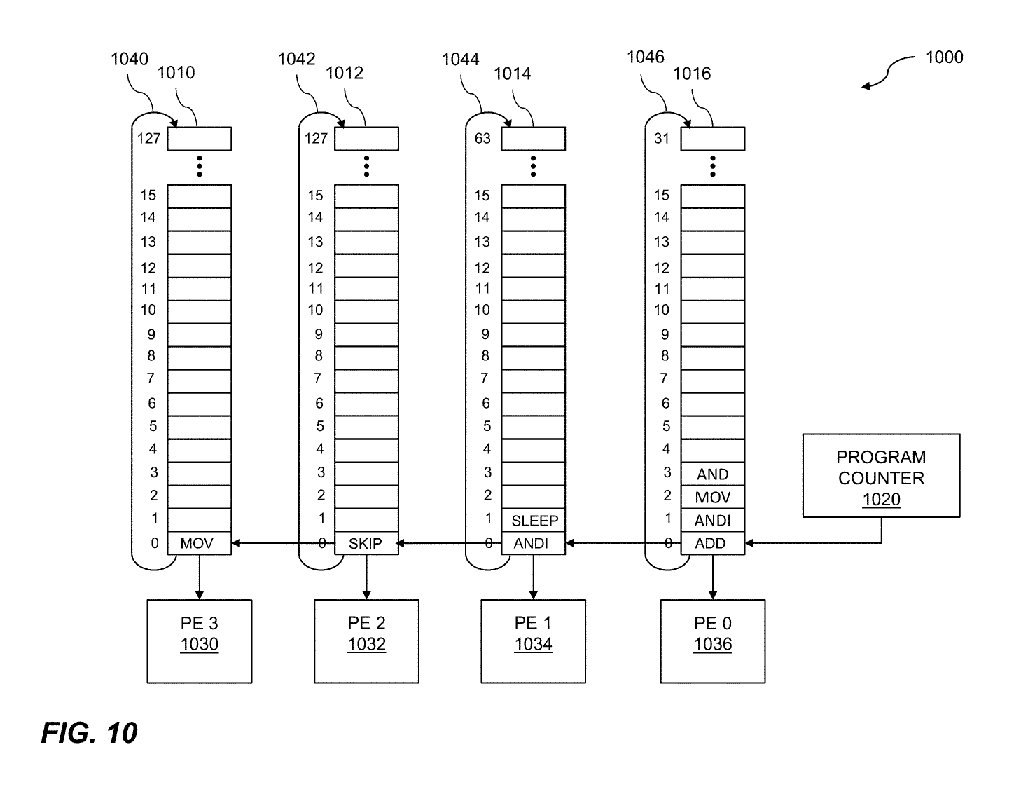

FIG. 10 illustrates a circular buffer and processing elements. The figure shows a diagram 1000 indicating example instruction execution for processing elements that can be used in tensor manipulation. A circular buffer 1010 feeds a processing element 1030. A second circular buffer 1012 feeds another processing element 1032. A third circular buffer 1014 feeds another processing element 1034. A fourth circular buffer 1016 feeds another processing element 1036. These circular buffers are shown with lengths of 128 entries, but various lengths are possible. The four processing elements 1030, 1032, 1034, and 1036 can represent a quad of processing elements. In embodiments, the processing elements 1030, 1032, 1034, and 1036 are controlled by instructions received from the circular buffers 1010, 1012, 1014, and 1016. The circular buffers can be implemented using feedback paths 1040, 1042, 1044, and 1046, respectively. In embodiments, the circular buffer can control the passing of data to a quad of processing elements through switching elements, where each of the quad of processing elements is controlled by four other circular buffers (as shown in the circular buffers 1010, 1012, 1014, and 1016) and where data is passed back through the switching elements from the quad of processing elements where the switching elements are again controlled by the main circular buffer. In embodiments, a program counter 1020 is configured to point to the current instruction within a circular buffer. In embodiments with a configured program counter, the contents of the circular buffer are not shifted or copied to new locations on each instruction cycle. Rather, the program counter 1020 is incremented in each cycle to point to a new location in the circular buffer. The circular buffers 1010, 1012, 1014, and 1016 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction. In this case, the instruction in the circular buffer can be ignored and the corresponding operation not performed.

The plurality of circular buffers can have differing lengths. That is, the plurality of circular buffers can comprise circular buffers of differing sizes. In embodiments, the circular buffers 1010 and 1012 have a length of 108 instructions, the circular buffer 1014 has a length of 64 instructions, and the circular buffer 1016 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 10, different circular buffers can have different instruction sets within them. For example, circular buffer 1010 contains a MOV instruction. Circular buffer 1012 contains a SKIP instruction. Circular buffer 1014 contains a SLEEP instruction and an ANDI instruction. Circular buffer 1016 contains an AND instruction, a MOVE instruction, an ANDI instruction, and an ADD instruction. The operations performed by the processing elements 1030, 1032, 1034, and 1036 are dynamic and can change over time, based on the instructions loaded into the respective circular buffers. As the circular buffers rotate, new instructions can be executed by the respective processing element.

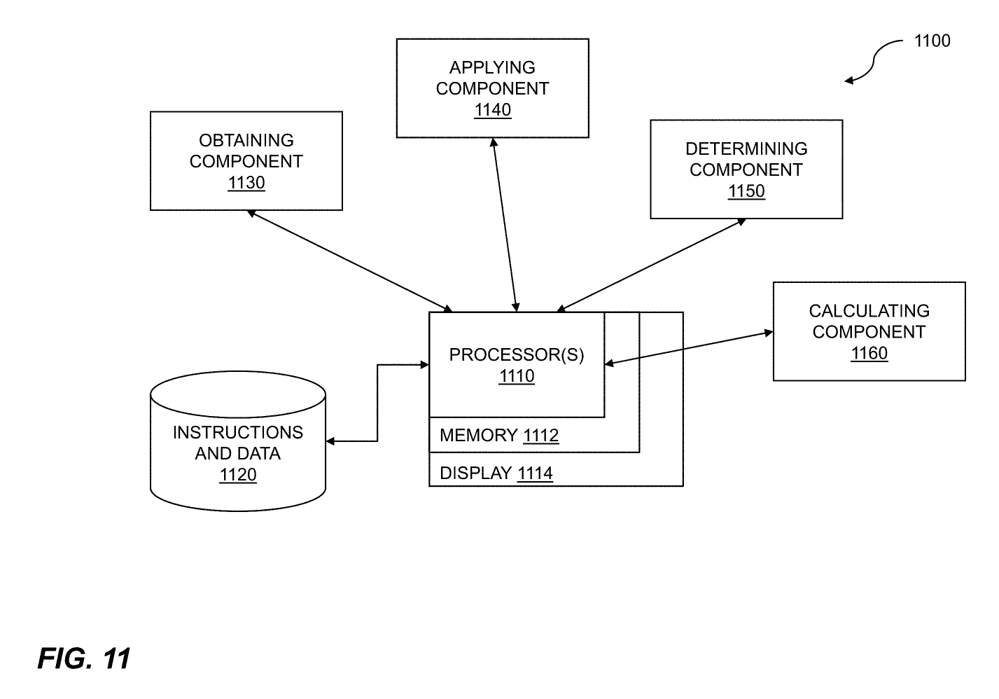

FIG. 11 is a system diagram for computational manipulation for tensor manipulation within a neural network. The system 1100 can include one or more processors 1110 coupled to a memory 1112 which stores instructions. The system 1100 can include a display 1114 coupled to the one or more processors 1110 for displaying data, intermediate steps, instructions, and so on. In embodiments, one or more processors 1110 are attached to the memory 1112 where the one or more processors, when executing the stored instructions are configured to: obtain a first input tensor for manipulation within a deep neural network, wherein the first input tensor includes fixed-point numerical representations, and wherein the first input tensor includes tensor metadata; apply the first input tensor to a first layer within the deep neural network, wherein the first input tensor with fixed-point values has a first set of variable radix points, wherein the first set of variable radix points is associated with the fixed-point values of the first input tensor; determine a first weighting tensor for the first input tensor applied to the first layer, wherein the first weighting tensor includes tensor metadata; calculate a first output tensor from the first layer within the deep neural network based on the first input tensor and the first weighting tensor, wherein the first output tensor has fixed-point values with a second set of variable radix points, wherein the second set of variable radix points is associated with the fixed-point values of the first output tensor, and wherein the first output tensor includes tensor metadata; and propagating the first output tensor within the deep neural network.

The system 1100 can include a collection of instructions and data 1120. The instructions and data 1120 may be stored in a database, one or more statically linked libraries, one or more dynamically linked libraries, precompiled headers, source code, flow graphs, kernels, or other suitable formats. The instructions can include instructions for tensor manipulation within a neural network. The instructions can include metadata that is determined for each tensor. The tensor metadata for each tensor can include tensor dimension, tensor element count, tensor radix points, tensor element precision, tensor element range, or tensor element classification. The instructions and data can include training data for a deep neural network included in a reconfigurable fabric.

The system 1100 can include an obtaining component 1130. The obtaining component 1130 can include functions and instructions for obtaining a first input tensor for manipulation within a deep neural network. The first input tensor can include fixed-point numerical representations and can include tensor metadata.

The system 1100 can include an applying component 1140. The applying component 1140 can include functions and instructions for applying the first input tensor to a first layer within the deep neural network. The first input tensor with fixed-point values can have a first set of variable radix points. The first set of variable radix points can be associated with the fixed-point values of the first input tensor. The system 1100 can include a determining component 1150. The determining component 1150 can include functions and instructions for determining a first weighting tensor for the first input tensor applied to the first layer. The first weighting tensor can include tensor metadata such as tensor dimension, tensor element count, tensor radix points, tensor element precision, tensor element range, or tensor element classification. The system 1100 can include a calculating component 1160. The calculating component 1160 can include functions and instructions for calculating a first output tensor from the first layer within the deep neural network based on the first input tensor and the first weighting tensor. The first output tensor can have fixed-point values with a second set of variable radix points. The second set of variable radix points can be associated with the fixed-point values of the first output tensor. The first output tensor can include tensor metadata such as tensor dimension, tensor element count, tensor radix points, tensor element precision, tensor element range, or tensor element classification. The tensor dimension can include the order, degree, rank, etc., of one or more arrays that can be used to represent the tensor.

The system 1100 can include a computer program product embodied in a non-transitory computer readable medium for computational manipulation, the computer program product comprising code which causes one or more processors to perform operations of: obtaining a first input tensor for manipulation within a deep neural network, wherein the first input tensor includes fixed-point numerical representations, and wherein the first input tensor includes tensor metadata; applying the first input tensor to a first layer within the deep neural network, wherein the first input tensor with fixed-point values has a first set of variable radix points, and wherein the first set of variable radix points is associated with the fixed-point values of the first input tensor; determining a first weighting tensor for the first input tensor applied to the first layer, wherein the first weighting tensor includes tensor metadata; calculating a first output tensor from the first layer within the deep neural network based on the first input tensor and the first weighting tensor, wherein the first output tensor has fixed-point values with a second set of variable radix points, wherein the second set of variable radix points is associated with the fixed-point values of the first output tensor, and wherein the first output tensor includes tensor metadata; and propagating the first output tensor within the deep neural network.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or reordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for computational manipulation comprising:
obtaining a first input tensor for manipulation within a deep neural network, wherein the first input tensor includes fixed-point numerical representations, and wherein the first input tensor includes tensor metadata;
applying the first input tensor to a first layer within the deep neural network, wherein the first input tensor with fixed-point values has a first set of variable radix points, wherein the first set of variable radix points is associated with the fixed-point values of the first input tensor;
determining a first weighting tensor for the first input tensor applied to the first layer, wherein the first weighting tensor includes tensor metadata;
calculating a first output tensor from the first layer within the deep neural network based on the first input tensor and the first weighting tensor, wherein the first output tensor has fixed-point values with a second set of variable radix points, wherein the second set of variable radix points is associated with the fixed-point values of the first output tensor, and wherein the first output tensor includes tensor metadata; and
propagating the first output tensor within the deep neural network.

2. The method of claim 1 wherein the tensor metadata is determined for each tensor.

3. The method of claim 2 wherein the tensor metadata for each tensor includes tensor dimension, tensor element count, tensor radix points, tensor element precision, tensor element range, or tensor element classification.

4. The method of claim 1 wherein each set of radix points is determined per tensor.

5. The method of claim 4 wherein each set of variable radix points determined per tensor is also determined per tensor dimension.

6. The method of claim 1 wherein a tensor is a multidimensional matrix.

7-8. (canceled)

9. The method of claim 1 wherein the first input tensor comprises deep neural network user training data.

10. The method of claim 1 wherein the first weighting tensor has fixed-point values with a third set of variable radix points, wherein the third set of variable radix points is associated with the fixed-point values of the first weighting tensor.

11. The method of claim 1 wherein the second set of variable radix points is a function of a preceding set of variable radix points associated with fixed-point values of a previous output tensor.

12. The method of claim 1 wherein the first set of variable radix points has different radix points for different blocks within the first input tensor.

13. The method of claim 1 wherein the propagating includes using the first output tensor as an input to a second layer within the deep neural network with a set of radix points for the input to the second layer.

14. The method of claim 1 further comprising using the second set of variable radix points to determine variable radix points for a next operation by the first layer.

15. The method of claim 1 further comprising training the deep neural network, based on the obtaining, the applying, the determining, and the calculating.

16. The method of claim 15 wherein the training includes forward propagation of activations.

17. The method of claim 16 wherein the training includes backward propagation of error.

18. The method of claim 17 further comprising adjusting the first weighting tensor based on the forward propagation and the backward propagation.

19. The method of claim 1 wherein the deep neural network is realized using a reconfigurable fabric.

20. The method of claim 19 wherein the reconfigurable fabric comprises processing elements, switching elements, or memory elements.

21. The method of claim 20 wherein the elements are controlled by rotating circular buffers.

22. (canceled)

23. A computer program product embodied in a non-transitory computer readable medium for computational manipulation, the computer program product comprising code which causes one or more processors to perform operations of:
obtaining a first input tensor for manipulation within a deep neural network, wherein the first input tensor includes fixed-point numerical representations, and wherein the first input tensor includes tensor metadata;
applying the first input tensor to a first layer within the deep neural network, wherein the first input tensor with fixed-point values has a first set of variable radix points, wherein the first set of variable radix points is associated with the fixed-point values of the first input tensor;
determining a first weighting tensor for the first input tensor applied to the first layer, wherein the first weighting tensor includes tensor metadata;
calculating a first output tensor from the first layer within the deep neural network based on the first input tensor and the first weighting tensor, wherein the first output tensor has fixed-point values with a second set of variable radix points, wherein the second set of variable radix points is associated with the fixed-point values of the first output tensor, and wherein the first output tensor includes tensor metadata; and
propagating the first output tensor within the deep neural network.

24. A computer system for computational manipulation comprising:
a memory which stores instructions;
one or more processors attached to the memory wherein the one or more processors, when executing the instructions which are stored, are configured to:
obtain a first input tensor for manipulation within a deep neural network, wherein the first input tensor includes fixed-point numerical representations, and wherein the first input tensor includes tensor metadata;
apply the first input tensor to a first layer within the deep neural network, wherein the first input tensor with fixed-point values has a first set of variable radix points, wherein the first set of variable radix points is associated with the fixed-point values of the first input tensor;
determine a first weighting tensor for the first input tensor applied to the first layer, wherein the first weighting tensor includes tensor metadata;
calculate a first output tensor from the first layer within the deep neural network based on the first input tensor and the first weighting tensor, wherein the first output tensor has fixed-point values with a second set of variable radix points, wherein the second set of variable radix points is associated with the fixed-point values of the first output tensor, and wherein the first output tensor includes tensor metadata; and
propagate the first output tensor within the deep neural network.
